(19) United States
(12) Patent Application Publication
(10) Pub. No.: US 2007/0209523 A1
(43) Pub. Date: Sep. 13, 2007

(54) INFUSION SYSTEM

(75) Inventor: Mickey Miceli, New Brighton, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: ABUNDANT CREATIONS, INC., New Brighton, MN (US)

(21) Appl. No.: 11/684,784

(22) Filed: Mar. 12, 2007

Related U.S. Application Data
(60) Provisional application No. 60/780,967, filed on Mar. 10, 2006.

(51) Int. Cl. A47J 31/00

(52) U.S. Cl. 99/279

(57) ABSTRACT

In one aspect, the present invention provides an apparatus for steeping a substance in a liquid. The apparatus includes a container. The container includes two pieces of container material joined together with a stitch. The stitch can be a straight stitch. The container is adapted to hold the substance. The apparatus also includes a loop. The loop extends away from the container. The loop includes a piece of loop material having two ends disposed between the two pieces of container material. The loop is adapted to slide over a spoon handle but not over a corresponding spoon bowl.

### CROSS-REFERENCE TO RELATED APPLICATION

This application claims priority under 35 U.S.C. §119(e) to U.S. provisional application 60/780,967, filed Mar. 10, 2006, which is hereby incorporated by reference in its entirety.

### TECHNICAL FIELD

This document relates to systems for easily infusing substances into liquids.

### BACKGROUND

There are several systems for infusing substances into liquids. Although many types of substances can be infused into liquids, perhaps the most common is tea. Thus, a common infusion system is a tea bag. Tea bags date back many years. When steeped in liquid, tea bags allow tea to brew within the bag, making it easier to dispose of the tea leaves without a tea strainer.

Some tea bags have a string stapled to one side, long enough for a tag stapled to the other end to remain out of the liquid while brewing. This allows users to remove such tea bags from the liquid without using a spoon or fingers. In some instances, however, the string can break away from the tea bag, forcing the user to remove the tea bag using a spoon or fingers. The same situation, can arise when the string and the bag inadvertently end up in the liquid.

### SUMMARY

In one aspect, the present invention provides an apparatus for steeping a substance in a liquid. The apparatus includes a container. The container includes two pieces of container material joined together with a stitch. The stitch can be a straight stitch. The container is adapted to hold the substance. The apparatus also includes a loop. The loop extends away from the container. The loop includes a piece of loop material having two ends disposed between the two pieces of container material. The loop is adapted to slide over a spoon handle but not over a corresponding spoon bowl. Many other configurations are possible, such as those disclosed herein.

### BRIEF DESCRIPTION OF FIGURES

FIG. 1 is a perspective view of an infusion system.

FIG. 2 is a different perspective view of the infusion system of FIG. 1.

FIGS. 3A-3G show various steps in an illustrative process of making the infusion system of FIGS. 1-2.

FIG. 4 is a perspective view of an infusion system.

FIGS. 5A-5E show various steps in an illustrative process of making the infusion system of FIG. 4.

### DETAILED DESCRIPTION OF ILLUSTRATIVE EMBODIMENTS

The figures accompanying this document illustrate many of the novel features of the present invention. The figures depict illustrative embodiments and are not intended to limit the scope of the invention. Rather, the present invention is defined solely by the claims.

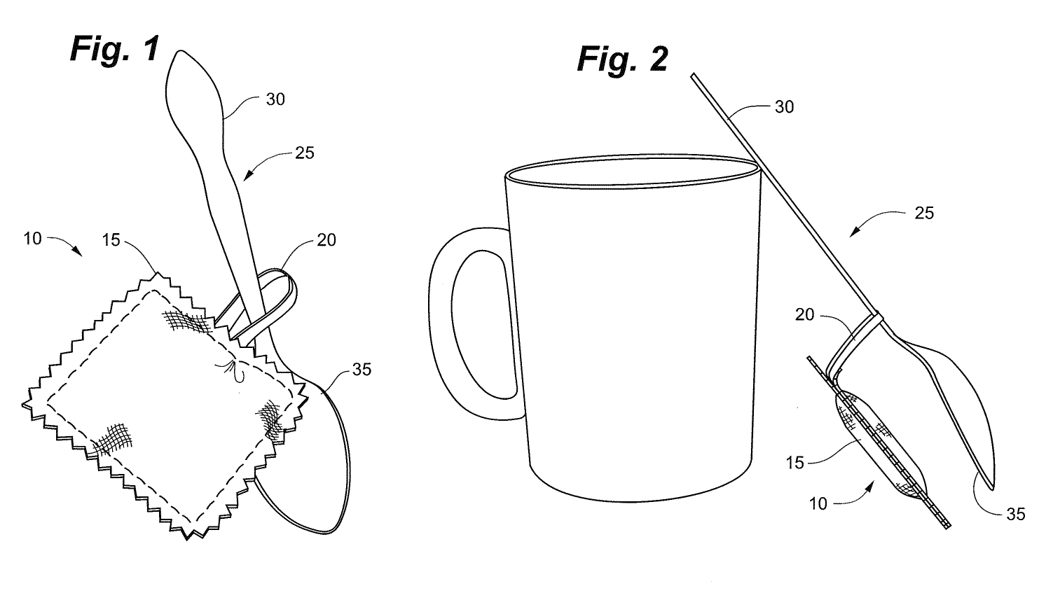

FIGS. 1-2 show an infusion system 10. The system includes a container 15 (made of cloth or other suitable material) that holds a substance (such as coffee, espresso, tea, soup, Kool-Aid®, broth, cocoa, powdered milk, or other substances suitable for steeping in a hot or cold liquid). The container 15 includes a loop 20 extending outwardly from one of its edges. The loop 20 is sized to slide along the handle 30 of a spoon 25 or other similar utensil but to contact the spoon's bowl 35 (i.e., the scooping part of the spoon), which prevents the loop 20 from sliding over the spoon's bowl 35. In this way, the container 15 and the spoon 25 can be placed into a liquid for steeping.

The infusion system of FIGS. 1-2 provides numerous advantages. For instance, it allows the user to stir the container 15 while liquid passes through the container 15, thereby helping with the steeping process. Additionally, after the steeping process is completed, the user can simply lift the spoon 25 out of the liquid, which will consequently lift the container 15 out of the liquid. In other words, unlike a string on a tea bag, a user never has to “fish” for the container 15 to get it out of the liquid—it is automatically removed when the spoon 25 is pulled out. Moreover, because of the position of the container 15 relative to the spoon 25, the user can further enhance the steeping process by pressing the spoon 25 against the side of the cup (or bowl or other liquid receptacle) to squeeze out additional substance.

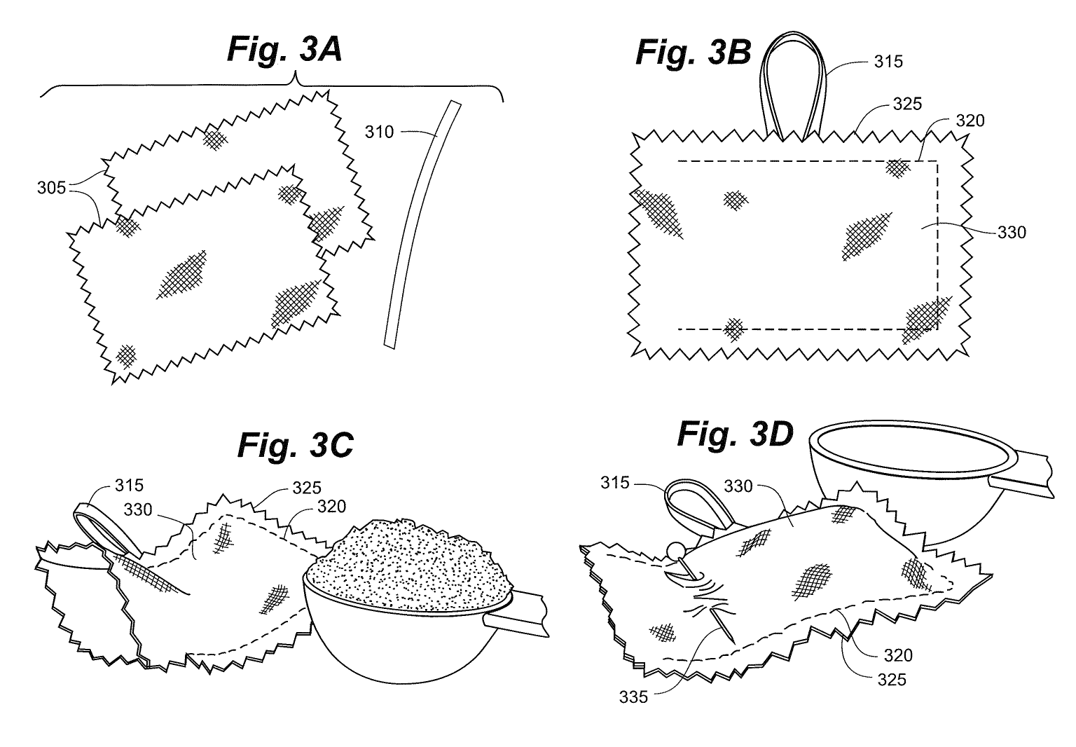

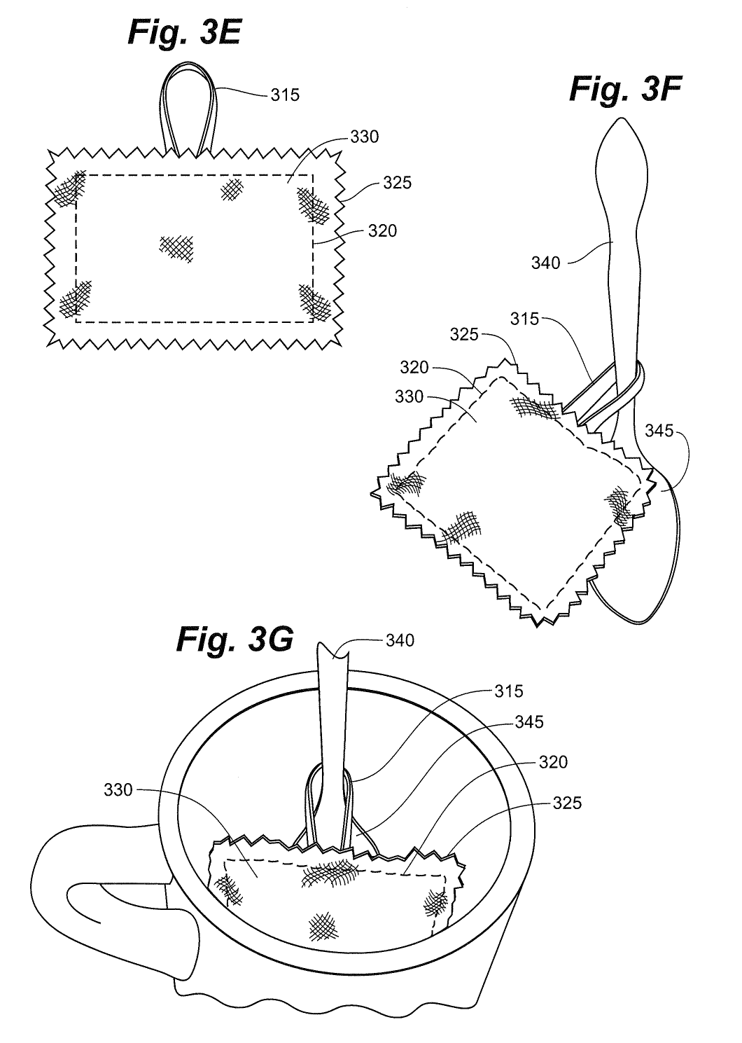

The infusion system of FIGS. 1-2 can be made in a variety of ways. FIGS. 3A-3G show an illustrative process. For instance, a maker can cut two shapes 305 (e.g., rectangles) out of fabric. The fabric could be infused with flavor (e.g., cinnamon, lemon, orange, etc.). The fabric could be decorated (e.g., seasonal, whimsical or designer fabrics, company logos, etc). The size of the rectangles could be the size of an average tea bag (approximately 2½×2¼ inches). In some embodiments, the sides of the fabric can be approximately 1½ to 2 inches. To do the cutting, the maker could use a pinking shears or decorative scissors for a more decorative edge. The maker can then place the rectangles together. The maker can then cut material 310 to be used for making the loop 315. The loop 315 is often decorative ribbon or string that is roughly 2.5 inches long. The maker can then fold the ribbon/string in the middle and place both ends between the two fabric rectangles (making sure that the loop is sized properly when the container is sewn). The loop 315 is often placed near the midpoint of one of the rectangles' edges. The maker can then secure the loop 315 in place (e.g., by a pin). Then the maker can sew along three edges of the rectangles to secure the rectangles and the loop 315 together. The maker can use a straight stitch 320 (e.g., a 2.5). The maker can leave space between the stitch 320 and the edge 325 of the fabric to create a decorative edge. The maker can then add the substance to the container 330 (e.g., two spoonfuls of coffee), given that three sides are closed and one side is open. The maker can the shake the container 330 to make sure the substance is properly packed. The maker can then secure the substance in place (e.g., with a pin 335) to prepare the container 330 for being sewn shut. Then the maker can sew along the fourth edge of the rectangles to close the container 330. With the container 330 completed, the maker can slide the loop 315 over the handle 340 of the spoon until it contacts the spoon's bowl 345. At that stage, the infusion system is ready to be steeped in a liquid. This process of making the infusion system is only illustrative.

Using a straight stitch 320 in the manufacturing process, as opposed to an over-locking serge stitch, provides many advantages. For example, when an over-locking serge stitch is used, the loop is generally made by attaching the “tail” of string to the container, which can be difficult in many situations. In contrast, using a straight stitch 320 to construct the container accommodates the loop 315 being made of a ribbon/string. And it is substantially easier to attach the ribbon/string to the container 330 than it is to attach the “tail” of string to the container 330. Moreover, a loop made of the “tail” of string is not as stable, secure, sturdy, or strong as a loop made of the ribbon/string. Additionally, given the uncertainty involved in the over-locking serge stitch “catching” the “tail,” it can be difficult to precisely position the loop 315 relative to the container 330 (e.g., near one of the container's corners, at the midpoint of one of the container's edges, etc.) when the loop is made from the “tail” of string. On the contrary, a ribbon/string loop 315 can be easily positioned relative to the container 330.

Another advantage of making loops out of ribbon/string, as opposed to making them from the “tail” of string, is that measuring the size of the loop 315 can be done on a predictable, repeatable basis. The size of the loop 315 is important—if it is too small, it will not be able to slide over the spoon's handle 340; if it is too large, it will slide over the spoon's bowl 345 and is lost in the liquid. Creating a loop using the “tail” of string does not allow for predictable, repeatable loop size because the over-locking serge stitch “catches” the “tail” of string in an unpredictable fashion. On the other hand, loops made of ribbon/string can be created to be a particular size on a consistent basis—it is just a matter of cutting the ribbon/string to the desired length. Another advantage of a loop 315 made out of ribbon/string is that they have a more aesthetic appearance.

In some circumstances, infusion systems that use an over-locking serge stitch could incorporate a loop made out of ribbon/string. In such embodiments, a loop made of ribbon/string would be attached to one side or the other of an infusion system using an over-locking serge stitch (though it could not be positioned between the two pieces of fabric of the container). As such, the container would have a front side and a back side, which could be undesirable in some instances (e.g., when a logo is on only one side of the container). Furthermore, a loop made out of ribbon/string would be attached to an infusion system using an over-locking serge stitch such that the loop extended inwardly toward the container rather than away from the container. Such an infusion system could be less desirable than one in which the loop extended away from the container (e.g., it could be more difficult to slide onto a spoon, it could be more difficult to display in a commercial setting, etc.).

The minor drawbacks associated with infusion systems that use an over-locking serge stitch and loops made out of ribbon/string are overcome by a system using a straight stitch 320. For example, in a straight stitch infusion system, the ribbon/string loop 315 can be placed between the two pieces 305 of fabric of the container, which makes the infusion system generally symmetrical (i.e., it does not have a front side and a back side). Also, as shown in the embodiment of FIGS. 3A-3G, the loop can extend away from the container in a straight stitch infusion system.

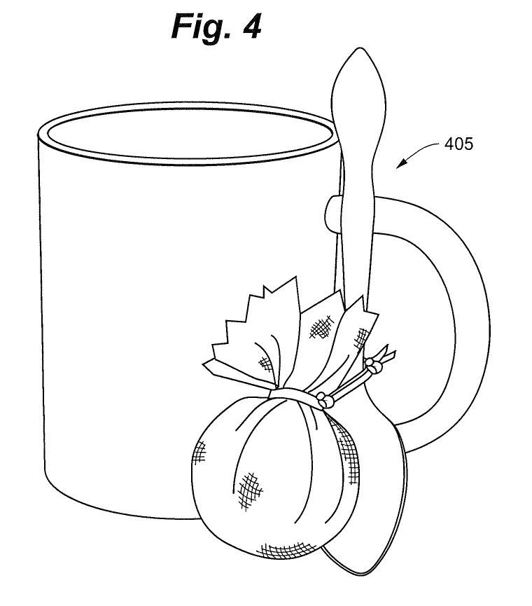

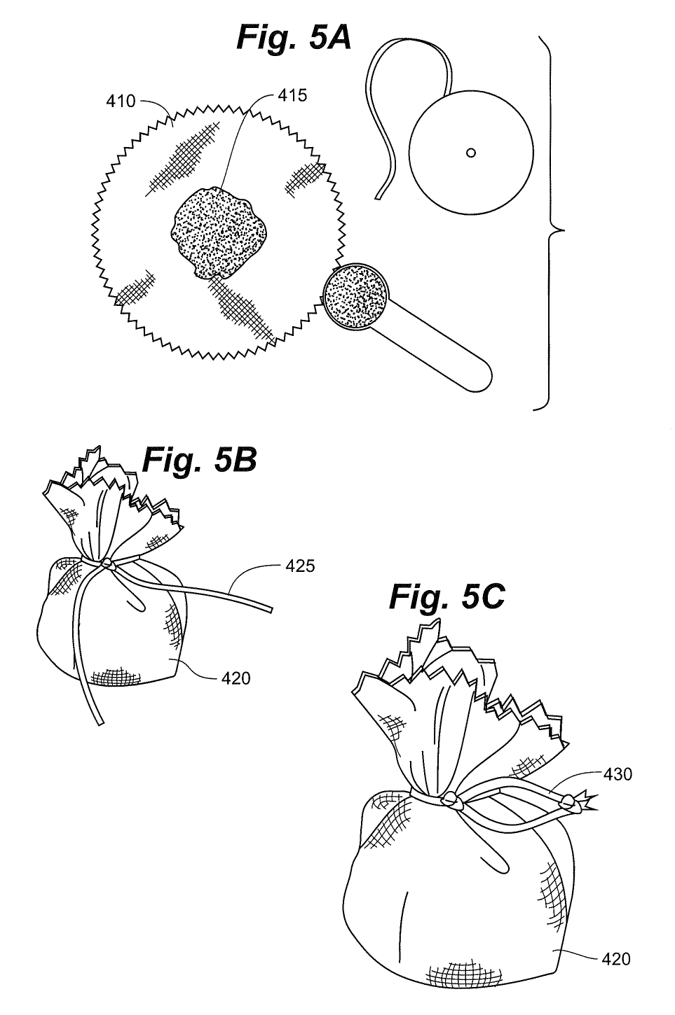

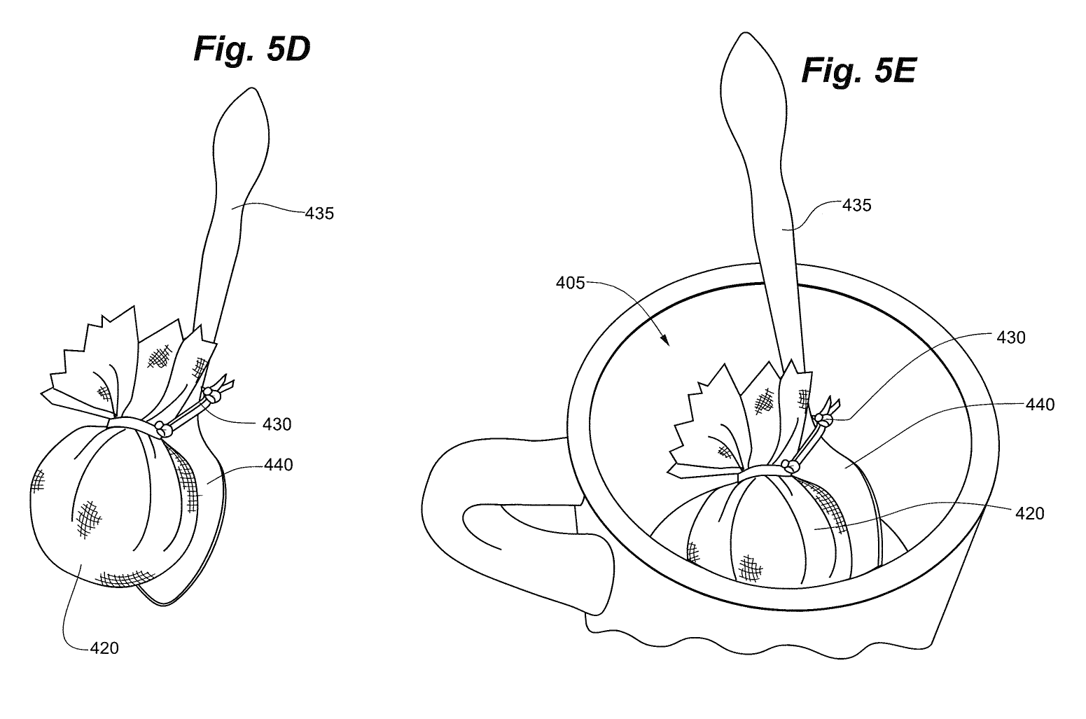

FIG. 4 shows another infusion system embodiment 405. Much of what is discussed in connection to the embodiment of FIGS. 1-2 is also applicable to the embodiment of FIG. 4. FIGS. 5A-5E show an illustrative process for making the infusion system 405. This infusion system 405 can be made by cutting a circle 410 out of fabric. In some embodiments, the diameter is approximately six inches. The maker can then place a substance 415 to be steeped (e.g., approximately 1.5-2.0 tablespoons of espresso coffee) on the circle 410. The maker can bring the edge of the fabric together to make a pouch 420. The maker can then tie a piece of ribbon 425 or decorative string around the fabric (i.e., just above the pouch of coffee). The maker can then make a loop 430 (with similar properties to the loop discussed in connection with FIGS. 1-5) with the remaining ribbon or decorative string. With the pouch 420 completed, the maker can slide the loop 430 over the handle 435 of the spoon until it contacts the spoon's bowl 440. At that stage, the infusion system 405 is ready to be steeped in a liquid.

Thus, embodiments of the infusion system are disclosed. One skilled in the art will appreciate that the infusion system can be practiced with embodiments other than those disclosed. The disclosed embodiments are presented for purposes of illustration and not limitation, and the present invention is limited only by the claims that follow.

What is claimed is:

1. An apparatus for steeping a substance in a liquid, comprising:
a container including two pieces of container material joined together with a stitch, the container being adapted to hold the substance; and
a loop extending from the container and including a piece of loop material having two ends disposed between the two pieces of container material, the loop being adapted to slide over a spoon handle but not over a corresponding spoon bowl.

2. The apparatus of claim 1, wherein the stitch is a straight stitch.
